(19) United States
(12) Patent Application Publication
(10) Pub. No.: US 2011/0118070 A1
(43) Pub. Date: May 19, 2011

(54) TRANSMISSION DEVICE COMPRISING A TRANSMISSION HOUSING

(75) Inventors: Wolfgang Purretat, Burkardroth (DE); Ralf Ronnebeck, Schonugen (DE); Alexander Schaflein, Schweinfurt (DE); Bernard Hunold, Friedrichshafen (DE); Kai Borntraeger, Langenargen (DE); Rene Budach, Ravensburg (DE); Max Bachamann, Bad Waldsee (DE); Alexander Gehring, Hassfurt (DE)

(73) Assignee: ZF FRIEDRICHSHAFEN AG, Friedrichshafen (DE)

(21) Appl. No.: 13/003,008

(22) PCT Filed: Jul. 16, 2009
(86) PCT No.: PCT/EP09/59147

§ 371 Date: Jan. 7, 2011

(30) Foreign Application Priority Data
Jul. 17, 2008 (DE) 10 2008 040 493.4

(51) Int. Cl. F16H 47/08; F16H 47/06

(52) U.S. Cl. 475/5; 74/720; 180/65.22

(57) ABSTRACT

A transmission device (1) having a transmission housing (2) in which several assemblies can be positioned for creating different gear ratios, and a start-up device, preferably a hydrodynamic torque converter. At least one breakout (3, 13) is provided in the wall area of the transmission housing (2), where the edge areas (4) are designed as stiffening zones and through which the torque is brought from the transmission housing (2) to auxiliary drive trains. In the area (5) of the transmission housing (2), which is designated for a start-up device, at least one electric machine (6) of a hybrid system is provided. A connection of the electric machine (6), which is positioned in the transmission housing (2), to power electronic located external of the transmission housing (2), is brought through the at least one breakout (13) of the transmission housing (2).

This application is a National Stage completion of PCT/EP2009/059147 filed Jul. 16, 2009, which claims priority from German patent application serial no. 10 2008 040 493.4 filed Jul. 17, 2008.

### FIELD OF THE INVENTION

The invention concerns a transmission device with a housing.

### BACKGROUND OF THE INVENTION

Known in practice, and preferably constructed as an automatic transmission, are transmission devices which are each designed as a wall section of a transmission housing in a way so that openings can mechanically be added to the wall section of the transmission housing, when required, through which the torque can be passed from the within the transmission housing to the outside of the transmission housing where the auxiliary output drives are positioned. To ensure stiffening of such transmission housings after the later addition of openings, the edge areas of the openings are equipped with stiffening zones.

These configured wall areas of a transmission housing of a transmission device are positioned, for instance, between a provided start-up device, designed as a hydrodynamic torque converter, and different assemblies which generate different gear ratios of the transmission device.

To realize a reduction of the fuel consumption of commonly known gasoline or diesel combustion engines during the different stages of operation, vehicles and their vehicle drive trains, respectively, become more and more equipped with electric machines. A disadvantage is the fact that hybrid vehicle drive trains are characterized by the need for a large installation space and that it can often only be achieved through elaborate, structural changes in the area of the vehicle body in which the additional electric machine has to be placed.

### SUMMARY OF THE INVENTION

Therefore, it is the task of the present invention to provide a transmission device with a transmission housing through which conventional vehicle systems can be designed with hybrid drives, without constructive modifications.

The inventive transmission device comprises a transmission housing, in which several assemblies can be positioned to provide different gear ratios, as well as a start up device, preferably a hydrodynamic torque converter, and breakouts are provided in a wall area of the transmission housing, their edge areas are designed with stiffening zones through which the torque can be brought from the transmission housing to the auxiliary drives of the vehicle, at least one electric machine of a hybrid system is positioned in the area of the transmission housing which is provided for the start-up device, and which, via at least one of the breakouts of the transmission housing, has a connection with the electric machine, positioned in the transmission housing, and provided power electronics, that are external of the transmission housing.

Thus, the transmission device in this invention, contrary to the torque converter transmission devices known in practice which have been equipped in the transmission housing with a start-up device which is designed with a hydrodynamic torque converter, has in the inner section of the transmission housing, as known in practice, at least one electric machine of a hybrid system which is connected to a related power electronic, where the power connections match the respective housing conditions of the transmission housing and also at a reasonable manufacturing cost.

Furthermore and in accordance with the invention, a vehicle drive train which is equipped with such a transmission device presents a hybrid drive train, in comparison to conventional drive trains without hybrid systems, which needs at least approximately the same amount installation space, but can be cost effectively implemented into existing vehicle systems. This results from the fact, that an additional electric machine is positioned in an existing transmission housing of a transmission device, preferably designed as a torque converter automatic transmission, and that the body areas of a vehicle system which accommodate the vehicle drive train do not require constructive modifications.

In a further, advantageous embodiment of the transmission device in accordance with the invention, a rotor of the electric machine is drivingly connected to a ring gear of a planetary transmission device of the hybrid system and the ring gear meshes with planetary gears of the planetary transmission device, which then again mesh with a sun gear that is attached to the housing, whereby torque, generated by the electric machine, can be directed via a planetary carrier, into the power flow of the transmission device. Hereby, for example during the start-up operation in a vehicle drive train, which is equipped with the inventive transmission device, starting torque generated by the electric machine can be directed into the power flow of the transmission device or a vehicle drive train, respectively. In addition or as an alternative, this designed system allows, among other things, a pure electric drive of the vehicle when the electric machine operates as a generator or as a motor, a mixed drive operation with the electric machine and coupled to, preferably via a shift element, a vehicle drive train of a drive machine, designed as a combustion engine, or a pure drive machine operation can be performed whereby, during the mixed drive operation by means of the electric machine, a boost operation is possible, as is a recuperation operation.

### BRIEF DESCRIPTION OF THE DRAWINGS

Additional advantages and further advantageous embodiments of the invention are specified in the claims with reference to the embodiment as described in principle in the drawing.

It shows:

FIG. 1 a highly schematic presentation of the invented transmission device;

FIG. 2 a simplified longitudinal sectional view of the transmission device, as presented in FIG. 1 and along the details of the dotted line II-II, and

FIG. 3 a longitudinal sectional view of the marked area III of the transmission device as in FIG. 1.

### DETAILED DESCRIPTION OF THE PREFERRED EMBODIMENTS

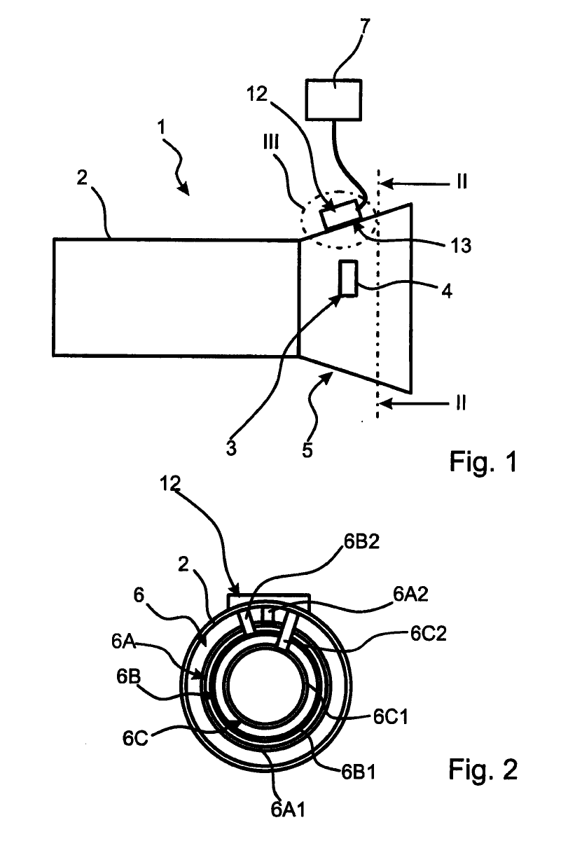

FIG. 1 shows a highly schematic presentation of a transmission device 1 with a transmission housing 2, in which different assemblies, not further presented in the drawing, are positioned to achieve the different transmission ratios, and a start-up device, designed as a hydrodynamic torque converter. In a wall area of the transmission housing 2, several breakouts 3, 13 are provided where the edge areas 4 have stiffening zones, and through which the torque can be transferred from within the transmission housing 2 to the externally, from the transmission housing, positioned auxiliary output drives of a vehicle which has a transmission device 1.

The breakouts 3, as known in the state of the art, are accordingly achieved during an adequate casting, manufacturing operation, preferably during a die casting manufacturing operation, so that, without negatively impacting the stiffness of the transmission housing 2, the wall areas of the transmission housing 2 surrounded by the edge areas 4 can be mechanically removed, where required, through processes such as drilling or similar, to create the presented rectangular openings in the walls of the transmission housing 2.

The transmission housing 2, as shown in the art and in the drawing, is designed with several breakouts 3, 13 which are circumferentially positioned in the transmission housing 2 to connect, where required, several auxiliary output drives of a vehicle with the power flow of the transmission device 1. The connection of the auxiliary output drives with the power flow of the vehicle drive train in the area of the transmission device 1 is, for instance, possible through several spur gears which mesh with each other and which create the so-called gear chains.

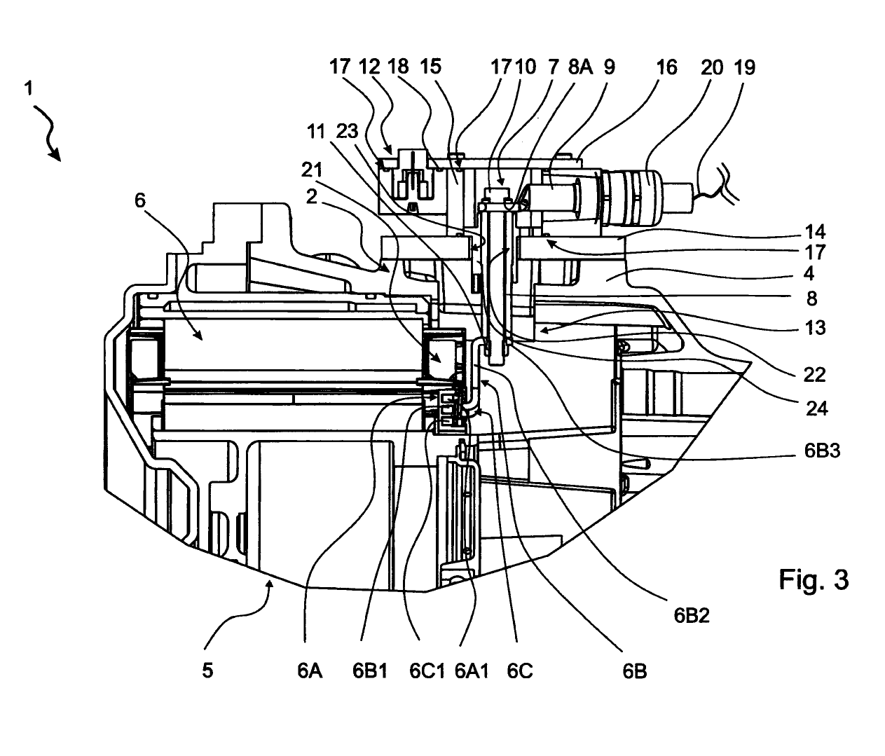

In the area 5 of the transmission housing 2, in which the start-up device or rather the hydrodynamic torque converter can be positioned in a design of the transmission device 1 as a torque automatic transmission, the present FIG. 2 and FIG. 3 further illustrate an electric machine 6 of a hybrid system, whereby a connection 7 of the electric machine 6, positioned in the transmission housing 2, with the power electronic is brought through at least one of the breakouts 13 of the transmission housing 2.

The electric machine 6 is configured as a permanent magnet excited synchronous machine which can be operated through an alternating current. Each phase of the electric machine 6 is connected to a shift ring 6A, 6B, 6C, whereby the wires of the different coil windings for each phase of the electric machine 6 are connected to one end of each of the respective assigned shift rings 6A to 6C which face the electric machine 6.

The shift rings 6A to 6C are at least of identical construction and have a first ring area 6A1, 6B1, or 6C1, respectively, which extends in an axial direction of the electric machine 6, and a second shift ring area 6A2, 6B2, 6C2, which extends in an axial direction from the first ring area 6A1 to 6C1 in the direction of an outer, radial area of the electric machine 6, and has, extending again mainly in the axial direction of the electric machine 6, a third shift ring area, whereby the drawing just shows the third shift ring area 6B3 of the second or rather center shift ring 6B.

The shift rings 6A to 6C are each functionally connected in the area of the first ring area 6A1, 6B1, or 6C1, respectively, with the coil windings of the assigned phases of the electric machine 6. The first ring areas 6A1 to 6C1 of the shift rings 6A to 6C are radially positioned within winding head protrusions 21 of the coil windings of the electric machine 6 and are connected to the coil windings underneath the winding head protrusions 21.

In this presentation, the term winding head protrusion of the electric machine 6 is each meant as a winding of the stator tooth with coil wire or a copper wire. Due to the winding head protrusions 21, the electric machine 6 has a larger axial length than the length of the given sheet metal package of the electric machine 6, because the coil wire windings extend in this area above the sheet metal package.

The coils of the stator which are radially distributed at the circumference of the stator of the electric machine 6 have contacts and a connection 7 to the three phases of the power electronic via the shift rings 6A to 6C. In a favorable construction design, the shift rings 6A to 6C, also designed as copper rings, are at least partially positioned in the radial direction underneath the winding head protrusions 21. The shift rings 6A to 6C which represent the respective phases are incorporated in a plastic part, not shown in detail here, and are fixed mounted through it at the stator of the electric machine 6. The ends of the coil windings of the electric machine 6 lay, during the assembly of the electric machine 6, on the shift rings 6A to 6C and are attached to them. After that, the shift ring holder or rather the plastic part and also the stator itself, will be isolated by means of a hardening, impregnating resin.

In the inside of the transmission housing 2, the shift rings 6A to 6C are each detachably connected via the connecting device 7 to a sleeve element 8 which feeds through the transmission housing 2. The sleeve elements 8 each lay on the third shift ring area 6B3 of the shift rings 6A to 6C and create herewith the electrical contact. Outside of the transmission housing 2, the sleeve elements 8 are fixedly connected to the cable lugs 9 of the connecting device 7, the cable lugs 9 each lay on the front side 8A of the electrically conducting sleeve elements 8.

The connecting devices 7 each have screw elements 10 which extend through the sleeve elements 8, with the screw elements each being connected in the area of the third shift ring 6B3, via screw-nut devices 11, to the shift rings 6A to 6C. The sections of the sleeve elements 8 which are positioned outside of the transmission housing 2, as well as the assigned cable lugs 9, are positioned in a housing device 12 which is here in this case, in the section of a breakout 13, fixed and sealed connected to the transmission housing 2 of the transmission device.

The housing device 12 is designed with a flange type of bottom beam plate 14, an intermediate housing area 15, and a cover plate 16, whereby the housing device 12 is connected, fixed and sealed in the section of the bottom beam plate 14, with the transmission housing 2. To seal the inside of the transmission housing 2 in reference to the surrounding, a sealing device 17 is each provided between the bottom beam plate 14 and the intermediate housing area 15, and between the cover plate 16 and the intermediate housing area 15, which comprises, in each case, fitted round cord seals in milled grooves 18 to achieve the sealing.

Furthermore, the housing device 12, in the section of the bottom beam plate 14, has an opening 23 which is congruent with the breakout 13 of the transmission housing 2, in an assembled condition of the housing device 12, where, in the section of the opening 23, a guiding device 24 is provided which is fixed in connection to the bottom beam plate 14, and through which the sleeve elements 8, each via the provided bore holes 22, are brought to the inside of the housing device 12.

A cable device 19, connected to a cable lug 9, is brought, in the section of the intermediate housing area 15, from the housing device 12 towards the direction of the power electronic 7, and is connected, fixed and sealed via a cable fitting 20, which is preferably a PG fitting, with the housing device 12.

Thus, the electric machine 6 is designed in a way so that the provided shift rings 6A to 6C act as the contacts for the coil windings of the electric machine 6 in the assembled state of the electric machine 6 and, as shown in FIG. 2, positioned underneath the breakout 13 or the so-called auxiliary output window of the transmission housing 2.

After assembling the electric machine 6 in the inner section of the transmission housing 2, the power connection of the electric machine 6 is completed through the breakout 13 or through the auxiliary output window of the transmission housing 2. The bottom beam plate 14, which has been provided with the opening 23 for the insertion of the sleeve elements 8, is initially placed on the window of the breakout 13 and screwed to the transmission housing 2. To accommodate a junction box, which comprises the guiding device 24, the intermediate housing area 15, and the cover plate 16, the bottom beam plate 14 is designed with a connecting flange.

After screwing the bottom beam plate 14 to the transmission housing 2, the guiding device 24 is screwed to the bottom beam plate 14. The guiding device 24 is designed with three bore holes 22, into which the provided sleeve elements 8, designed as copper sleeves, are pressed in. The bore holes 22 of the guiding device 24 are oriented in the assembled state of the guiding device such that the assembled sleeve elements 8 bear on the third shift ring areas 6B3 of the shift rings 6A to 6C.

Thereafter, the intermediate housing area 15 is placed on the bottom beam plate 14, and the seal between these two parts is realized through a sealing device 17, preferably designed as a fitted round cord seal. Thereafter, the cable devices 19 of the power connections are cut to the desired length and are equipped with the cable lugs 9. Again thereafter, the cable 19 with the cable lugs 9 are brought through the cable fittings 20 and, by tightening the cable fittings 20, are connected, fixed and sealed to the housing device 12.

The axial length of the sleeve elements 8 is aligned in such a way that the cable lugs 9 lay on the front sides 8A of the sleeve elements 8. The contact between the cable lugs 9, the sleeve elements 8, and the shift rings 6A to 6C is achieved in a way that each one of the screw elements 10 is rotated through the bore holes of the cable lugs 9 and the sleeve elements 8. In the section of the third shift ring areas 6B3 of the shift rings 6A to 6C, a screw element 10 engages with the thread of a screw-nut device 11, which are each designed as a threaded bushings, and is then tightened.

Finally, the cover plate 16 is set on the intermediate housing area 15, where the inner area of the transmission housing, in the section between the intermediate housing area 15 and the cover plate 16, is again sealed by means of a sealing device 17 or a round cord seal to be inserted into a groove 18.

In the present embodiment of the transmission device 1, a rotor of the electric machine 6 is in operational connection with a ring gear of a planetary transmission device of the hybrid system which is not further described here. The ring gear meshes with planets of the planetary transmission device which then mesh with a sun gear, fixed to the transmission housing, such that torque, which is generated by the electric machine 6, can be transmitted via a planetary carrier into the power flow of the transmission device 1, in the section of the transmission input shaft.

The electric machine 6 presents a start-up device for a vehicle drive train which is equipped with the transmission device 1, whereby the vehicle is preferably started in a purely electric operation via the motor driven electric machine 6. The functionality of a start-up device with a hydrodynamic torque converter, which is needed in conventional vehicle drive trains designed with combustion engines as start-up machines, is not required during an electric machine driven start-up procedure, thus, the hydrodynamic torque converter becomes obsolete with the installation of the electric machine 6.

A main engine which is designed as a combustion engine can be coupled, via a frictionally engaging shift device, with the transmission device 1 in the vehicle drive train, depending on the operating condition. Hereby, the coupling area between the vehicle drive train and the main machine in relationship to the coupling area between the electric machine 6 and the output of the vehicle drive train, realized through the shift device, is positioned such that the main machine, in the power off condition, can be disengaged from the vehicle drive train during purely electric machine operation and that drive power of the electric machine 6, without power losses, can be transmitted in the direction of the output at higher efficiency, in the section of the turned-off main machine which has to be dragged by the electric machine 6.

In addition, when required the shift element provides the option of starting the vehicle via the main machine, if the shift device is operated as a start-up clutch.

In additional embodiments according to the invention, the electric machine 6 can also be coupled by other art and means to the power flow of the transmission device, to achieve the previously described operating conditions of a vehicle drive train.

### REFERENCE CHARACTERS

1 Transmission Device
2 Transmission Housing
3 Breakout
4 Edge Area
5 Area, Converter Housing
6A, B, C Shift Ring
6A1, B1, C1 first ring area
6A2, B2, C2 second shift ring area
6B3 third shift ring area
7 Connecting Device
8 Sleeve Element
8A Front Side of the Sleeve Element
9 Cable Lug
10 Screw Element
11 Screw-Nut-Device
12 Housing Device
13 Breakout
14 Bottom Beam Plate
15 Intermediate Housing Area
16 Cover Plate
17 Sealing Device
18 Groove
19 Cable Device
20 Cable Fitting
21 Winding Head Protrusion
22 Bore Hole
24 Opening
25 Guiding Device

1-13. (canceled)

14. A transmission device (1) with a transmission housing (2) in which several assemblies can be positioned for creating different gear ratios, and a hydrodynamic torque converter, at least one breakout (3, 13) is provided in a wall area of the transmission housing (2), where an edge area (4) of the at least one breakout (3, 13) forms a stiffening zone and torque is brought through the at least one breakout (3, 13) from within the transmission housing (2) to auxiliary drive trains,
at least one electric machine (6), of a hybrid system, being positioned in an area (5) of the transmission housing (2) designated for a start-up device, and
a connection being connected to the electric machine (6), which is positioned within the transmission housing (2), and passing through the at least one breakout (13) of the transmission housing (2) for connection to power electronics located exterior of the transmission housing (2).

15. The transmission device according to claim 14, wherein a rotor of the electric machine (6) is in an operating connection with a ring gear of a planetary transmission device of the hybrid system, and the ring gear meshes with planets of the planetary transmission device which, in turn, mesh with a sun gear that is fixed to the transmission housing such that torque, which is generated by the electric machine (6), is passed via the planetary carrier into a power flow of the transmission device (1).

16. The transmission device according to claim 14, wherein the electric machine (6) is a permanent magnet excited synchronous machine which is operated by an alternating current and each phase of the electric machine is connected to a shift ring (6A, 6B or 6C), and wires of different coil windings of each of the phases of the electric machine (6) are each connected to an end of an assigned shift ring (6A to 6C) which faces the electric machine (6).

17. The transmission device according to claim 16, wherein the shift rings (6A to 6C) each comprise a first ring area (6A1 to 6C1) which extends in an axial direction of the electric machine (6), a second shift ring area (6A2 to 6C2) which extends from the first ring area (6A1 to 6C1) in a direction of an outer radial section of the electric machine (6), and a third shift ring area (6B3) which extends generally in the axial direction of the electric machine (6).

18. The transmission device according to claim 17, wherein the first ring area (6A1 to 6C1) of each of the shift rings (6A to 6C) is operationally connected with the coil windings of assigned phases of the electric machine (6).

19. The transmission device according to claim 17, wherein the shift rings (6A to 6C) are each connected inside of the transmission housing (2) in the section of the third shift ring area (6B3) with a sleeve element (8), via a detachable connecting device (7), which feeds through the transmission housing (2), and the sleeve elements (8) each lay on the third shift ring area (6B3).

20. The transmission device according to claim 19, wherein the sleeve elements (8), outside of the transmission housing (2), are each connected with cable lugs (9), via the connecting device (7), and the cable lugs (9) are each on a front side (8A) of the sleeve elements (8).

21. The transmission device according to claim 19, wherein each connecting device (7) has screw devices (10), extending through the sleeve elements (8), which are each connected to the shift rings (6A to 6C) in a section of the third shift ring area (6B3) via screw-nut devices (11).

22. The transmission device according to claim 20, wherein areas of the sleeve elements (8), which are located outside of the transmission housing (2), and the assigned cable lugs (9), are positioned in a housing device (12) which is, in a section of the at least one breakout (13), is connected, fixed and sealed to the transmission housing (2).

23. The transmission device according to claim 22, wherein the housing device (12) has a flange type bottom beam plate (14), an intermediate housing area (15) and a cover plate (16), and the housing device (12) is connected to the transmission housing (2) via a section of the bottom beam plate (14).

24. The transmission device according to claim 23, wherein the housing device (12) is in the section of the bottom beam plate (14) and congruent with an opening, in an installed state of the housing device (12), with the at least one breakout (13) of the transmission housing (2), a guiding device (24) is fixedly connected to the bottom beam plate (14), and the sleeve elements (8) extend through the guiding device (24) and into an inside of the housing device (12).

25. The transmission device according to claim 20, wherein at least one cable device (19) is connected to the cable lug (9) and extends, in a section of an intermediate housing area (15), from the housing device (12) into a direction of the power electronic and is connected, fixed and sealed to the housing device (12) via a cable fitting (20).

26. The transmission device according to claim 16, wherein the first ring areas (6A1 to 6C1) of the shift rings (6A to 6C) are positioned radial within winding head protrusions (21) of the coil windings of the electric machine (6) and are connected to the coil windings in the areas underneath the winding head protrusions (21).
